(19) United States
(12) Patent Application Publication
(10) Pub. No.: US 2019/0078870 A1
(43) Pub. Date: Mar. 14, 2019

(54) Device For Optically Measuring An Object

(71) Applicant: Siemens Aktiengesellschaft, Muenchen (DE)

(72) Inventors: Thomas Engel, Aalen (DE); Martin Koerdel, Muenchen (DE)

(73) Assignee: Siemens Aktiengesellschaft, Muenchen (DE)

(21) Appl. No.: 15/703,824

(22) Filed: Sep. 13, 2017

(51) Int. Cl. G01B 9/02; G01B 11/02; G01B 11/24; G01B 11/30

(52) U.S. Cl. CPC G01B 9/0209; G01B 11/02; G01B 11/24; G01B 9/02028; G01B 9/02049; G01B 9/02065; G01B 11/30

(57) ABSTRACT

What is proposed is a device (1) for optically measuring an object, comprising an interferometer (2) having a measurement arm (21), wherein the measurement arm (21) is provided for optically measuring the object, and comprising a focusing element (3) arranged within the measurement arm (21). According to the invention, the device (1) comprises a first retardation element (4) arranged within the measurement arm (21) and downstream of the focusing element (3), wherein the first retardation element (4) has a movable displacement element (42), by means of which the optical path length of the beam path of the measurement arm (21) is variable.

### TECHNICAL FIELD

The invention relates to a device according to the preamble of patent claim 1.

It is known from the prior art to determine distances or spacings by means of laser radars, laser scanners or laser trackers. Particularly for medium to relatively large distances, the highest possible resolution is required here.

Furthermore, known measuring systems for optically detecting a distance or a spacing by means of a collimated light beam typically have a measurement spot having a size in the millimeters range. The area illuminated on the object by the light beam is designated here as measurement spot. The measurement spot is typically elliptical, in particular circular.

### BACKGROUND

A measurement of a variable spacing between the measuring system and the object to be measured is made significantly more difficult by virtue of the measurement spot, which is small in the sense mentioned above. For a measurement of the spacing that is as accurate as possible, it is therefore necessary to keep the size of the measurement spot in the operating range of the measuring system and as constant as possible independently of the spacing.

Known laser radars, laser scanners or laser trackers having a collimated light beam typically have a measurement spot size which is limited to the range of a millimeter up to a few millimeters.

Alternatively, the measurement spot is focused onto the object, that is to say onto a region of the surface of the object, by means of a zoom lens. What is disadvantageous about that is that the light beam can be laterally offset or displaced on account of a lens element movement within the zoom lens. Furthermore, the numerical aperture of the zoom lens can change over the operating range thereof. This in turn results in a change in the size of the measurement spot.

Alternative approaches, for example liquid lens elements for dynamically adapting the refractive power and thus the working distance, have limitations in the reproducibility of their focusing depending on the controlled variable used, for example depending on an applied voltage, a sound frequency or a sound amplitude. Furthermore, liquid lens elements have a different numerical aperture depending on their current refractive power. This in turn results in different sizes of the measurement spot. This disadvantage could be compensated for by means of a variable stop in the plane of the aperture. However, a variable portion of the light power is thereby lost, as a result of which the signal-to-noise ratio changes. Consequently, different imaging conditions are always present, which is disadvantageous.

### SUMMARY

The present invention addresses the problem of providing a device for optically measuring an object (measuring system) which enables a measurement spot having a size that is as constant as possible on a part of the surface of the object over the operating range of the device.

The problem is solved by means of a device having the features of independent patent claim 1. Advantageous configurations and developments of the invention are specified in the dependent patent claims.

The device according to the invention for optically measuring an object comprises an interferometer having a measurement arm, wherein the measurement arm is provided for optically measuring the object, and a focusing element arranged within the measurement arm. The subject matter of the invention is characterized in that the device comprises a first retardation element arranged within the measurement arm and downstream of the focusing element, wherein the first retardation element has a movable displacement element, by means of which the optical path length of the beam path of the measurement arm is variable.

The device according to the invention can also be referred to as device of the first type. On account of the movable displacement element, the device of the first type can be referred to symbolically as an optical trombone.

The optical measurement of the object requires at least the measurement of a partial region of the object. The object to be measured can be referred to as measurement object.

The device according to the invention is characterized in that a first retardation element having a displacement element for adapting the optical path length of the first retardation element is arranged within the measurement arm of the interferometer.

The optical path length of the first retardation element can also be referred to as retardation path.

An element is arranged within a measurement arm or beam path within the meaning of the present invention if the element functionally interacts with the light beam represented by the beam path during the operation of the device. In particular, the element thereby has an optical effect on the light beam used.

It goes without saying that a light beam is regarded as a descriptive model concept of a real beam of light having a spatial extent, as known to the person skilled in the art.

Furthermore, an arrangement of an element upstream or downstream of a further element always relates to a direction of the light beam used that prevails at the location of the element. An element is arranged directly upstream or directly downstream of a further element if no further element that interacts with the light beam is arranged between the element and the further element.

The first retardation element provided according to the invention has a beam path having an optical path length which is variable or adjustable by means of the movable displacement element. This advantageously enables a constant size of the measurement spot on the surface of the object to be measured within the operating range of the device according to the invention. Furthermore, the numerical aperture within the measurement spot is known and likewise virtually constant.

Before a description is given of further advantages of the device according to the invention, its basic functioning, which is comparable with the functioning of a laser radar in its fundamentals, will be explained briefly.

The device according to the invention comprises an interferometer for optically measuring the object and thus forms a laser radar in this sense. An interferometer typically has at least one measurement arm and also at least one reference arm. The respectively associated light beams, that is to say a measurement beam and also a reference beam, are caused to undergo interference. During operation of the device according to the invention, a coherent light source, in particular a laser, is typically tuned with regard to its frequency. In other words, the coherent light source has a chirp. A linear chirp is preferably used. As a result of the interference of the light beams (measurement beam and reference beam), which vary over time with regard to their frequency, a beat forms which is characteristic of the optical path difference between the measurement arm and the reference arm. If all contributions to the optical path difference are known apart from the spacing between the device and the object, then the optical spacing between the device and the object can be determined from said beat or from the beat signal or from the associated beat frequency. If the refractive index is known over the optical path length, then the geometrical spacing between the device and the object can be determined from the optical spacing.

By means of the movable displacement element—provided according to the invention—of the first retardation element, it is advantageously possible to achieve a measurement spot having a substantially constant size on the surface of the object.

Furthermore, the evaluation and the determination of the beat frequency can be optimized since the approximate position thereof in the frequency domain is known before a measurement. Moreover, the signal level of the beat signal can be increased by focusing of the measurement spot onto the surface of the object by means of a movement of the displacement element (displacement), that is to say a variation or adjustment of the optical path length of the first retardation element. The measurement sensitivity is increased as a result.

In other words, by means of the first retardation element provided according to the invention, the measurement arm of the interferometer can be adjusted in such a way that its focal point becomes located virtually on the surface of the object. Smaller variations can be provided in this case. Consequently, the measurement spot on at least one part of the surface of the object has a virtually constant size in conjunction with a uniform aperture. Furthermore, for this purpose the focusing element, for example a focusing lens element or an optical zoom lens, is arranged upstream of the first retardation element, in particular directly upstream of the first retardation element.

The first retardation element has an adjustable optical path length as a result of the displacement element provided according to the invention, such that the first retardation element forms an optical retardation section or an optical retardation path for the light beam of the measurement arm. The displacement element can be implemented by means of a linear displacement table.

The displacement element makes it possible to displace the operating point relative to the device axially, that is to say parallel to the measurement arm. In particular, the first retardation element can have a plurality of optical propagation paths for the light beam, wherein the optical path lengths of the individual propagation paths are varied in an identical way as a result of a displacement of the movable displacement element. Consequently, the total displacement path results from the product formed from the displacement path of the movable displacement element and the number of propagation paths. By way of example, given a displacement path of 200 millimeters (mm) and four propagation paths or light paths, this results in a total displacement path of the measurement spot of 4 times 200 mm=800 millimeters.

It is particularly preferred if the interferometer is embodied as a Michelson-Morley interferometer.

In principle, any design of an interferometer can be used for the device according to the invention. The Michelson-Morley interferometer has, in particular, the advantages of a known and simple construction. In a Michelson-Morley interferometer, the coherent light beam is split into the measurement beam and the reference beam by means of a semitransmissive mirror. The coherence is typically required to cause the measurement beam and the reference beam to undergo interference. As a result of the interference of the measurement beam and the reference beam, a beat or a beat signal forms which is characteristic of the difference in the optical path lengths (path difference) between the measurement beam and the reference beam. In other words, the beat frequency depends on said difference in the optical path lengths.

In accordance with one advantageous configuration of the invention, the first retardation element comprises at least two deflection elements, in particular prisms or mirrors, which are spaced apart from one another, wherein the deflection elements, in addition to their being spaced apart, have an offset with respect to one another and the spacing of the deflection elements is variable by means of the movable displacement element.

As a result, the light beam within the first retardation element is reflected back and forth between the two deflection elements typically repeatedly, in particular twice, particularly preferably four times, before said light beam emerges from the first retardation element. In other words, the first retardation element is embodied as a type of trombone, wherein the light beam is passed back and forth between the two deflection elements and the spacing between the two deflection elements is adaptable or adjustable by means of the movable displacement element.

In accordance with one advantageous configuration of the invention, the deflection elements are arranged in a manner rotated with respect to one another in such a way that the beam path of the first retardation element extends outside a plane.

If the beam path of the light beam within the first retardation element extends approximately in a plane, then there is the risk of sequence errors cumulating within the first retardation element, in particular as a result of a displacement or a variation of the optical path length by means of the movable displacement element. Therefore, it is advantageous to configure the beam path of the light beam within the first retardation element in such a way that it extends outside a plane, with the result that the undesired effects as far as possible compensate for one another. This can be implemented for example by means of a mirror or a rotated deflection element, in particular a rotated prism. In particular, with respect to each deflection of the light beam an associated deflection with an opposite direction can take place, with the result that said sequence errors largely compensate for one another in a complete pass of the light beam through the first retardation element.

In accordance with one advantageous development of the invention, at least one area of the first retardation element is at least partly reflectively coated in such a way that a light beam passing through the first retardation element is able to be returned at least partly to the interferometer.

It is particularly preferred here if a last element of the first retardation element has said area. A last element is an element of the first retardation element which, directly before the light beam leaves the first retardation element, is the last to be registered by the latter. Consequently, at least part of the light beam is reflected from said area back to the interferometer, as a result of which advantageously the optical path length of the first retardation element—once again by way of a beat frequency—is optically measurable. As a result, the spacing between the device and the object (free measurement length) can advantageously be determined by way of the relationship L_{free}=Lₘₑₐₛᵤᵣₑₘₑₙₜ−L_{retardation element}+C. Here L_{free} denotes the free (optical) measurement length, Lₘₑₐₛᵤᵣₑₘₑₙₜ denotes the measured optical path length, L_{retardation element} denotes the optical path length of the first retardation element, and C denotes a structural constant. Here the constant is a structurally fixed measure of the measurement length in relation to a distinguished difference point (reference point) for the measurement direction provided. The constant can thus assume positive or negative values. Furthermore, the constant can be implemented as a vector, for example by a beam direction, and/or be provided by a coordinate of a vector, for example within a coordinate system taken as a basis for the device.

Alternatively or supplementarily it is advantageous if the device comprises a sensor for detecting the movement of the movable displacement element.

Advantageously, the optical path length of the first retardation element can thereby be detected directly. In particular, the sensor can be a linear adjusting unit. In other words, the sensor can be embodied as a linear scale. The sensor and thus the direct optical detection of the optical path length of the first retardation element make it possible to directly detect the optical path lengths and adjustment paths that are crucial during the measurement. This is not possible in the case of an optical zoom, for example. Therefore, the abovementioned direct detection of the optical path length of the first retardation element makes it possible to concomitantly detect and take account of disturbance effects, for example over changing environmental conditions. In particular, the plausibility and/or the accuracy of the measurement of the object can be increased as a result.

Furthermore, the direct detection of the optical path length of the first retardation element could allow a refractive index correction of the ambient air of the device on account of a change in ambient conditions, such as temperature, air pressure and/or air humidity, for example.

In other words, the refractive index of the ambient medium, in particular of the ambient air, of the device can be determined by a comparison between the optical and geometric path lengths. The refractive index of the ambient medium can be determined without the object by means of a calibration of the device, in particular before the measurement of the object. This is particularly advantageous in particular in the case of changing operating conditions and/or environmental conditions. This enables a correction or a conditioning of the measurement results which provides a highly precise measurement of the object. By way of example, given a displacement path of 1000 millimeters (=2 times 500 mm) and a resolution of less than or equal to 10 micrometers, it is possible to determine the refractive index of the ambient medium with an accuracy of less than or equal to 10⁻⁵ (10 ppm).

However, the abovementioned direct optical detection of the optical path length by means of the at least partly reflectively coated area is more accurate. That is the case since the first retardation element typically has a plurality of light paths and the measurement deviations thus multiply with the number of light paths.

In accordance with one advantageous configuration of the invention, the device comprises a beam splitter element for splitting the measurement arm into a first and second partial measurement arm, wherein the beam splitter element is arranged downstream of the first retardation element, in particular directly downstream of the first retardation element, and the partial measurement arms are provided for optically measuring the object.

The device embodied in this way can also be referred to as device of the second type. On account of the displacement element and the two partial measurement arms, the device of the second type can be referred to symbolically as an optical trombone having a double arm.

The beam splitter element can comprise one or a plurality of beam splitters, one or a plurality of mirrors and/or one or a plurality of polarization beam splitters.

In other words, the measurement arm downstream of the first retardation element, in particular directly downstream of the first retardation element, is split into at least a first and a second partial measurement arm. In this case, the splitting is preferably carried out by means of a polarization beam splitter. As a result, it is advantageously possible to carry out measurement in different directions. The measurement signals of the partial measurement arms are unambiguously assignable to their associated partial measurement arm by way of the polarization.

The at least two partial measurement arms are advantageous in particular for a measurement within the object. As a result, it becomes possible to detect for example an internal diameter of the object directly by means of the device. In this case, it is possible to determine the internal diameter or diameter D by means of D=L_{free,1}+L_{free,2}, wherein L_{free,1} denotes the free measurement length of the first partial measurement arm and L_{free,2} denotes the free measurement length of the second partial measurement arm.

It is furthermore advantageous that the first and second partial measurement arms have a common first optical retardation element. That is advantageous since, as a result, the partial measurement arms are affected in the same way by sequence errors within the first retardation element. However, said sequence errors can be determined by means of at least one reference measurement and subsequently be compensated for.

Furthermore, the advantage is afforded that, in comparison with two separate retardation elements, significantly fewer optical and/or structural components are required in the case of a common first retardation element. As a result, the construction of the device is less complex and its structural size is more compact, as a result of which more robust operation of the device is made possible.

A further advantage of a beam splitter element embodied as a beam splitter is that the axial alignment, that is to say the directions of the two partial measurement arms, can be defined by way of the manufacture or manufacturing quality of the beam splitter. This is advantageous in particular for measuring an internal diameter or diameter D of the object. By way of example, it holds true that D=L_{free,1}+L_{free,2}−2L_{retardation element}−C, wherein once again L_{free,1} denotes the free measurement length of the first partial measurement arm, L_{free,2} denotes the free measurement length of the second partial measurement arm, L_{retardation element} denotes the optical path length of the first retardation element, and C denotes a constant. Said constant is structurally defined and, for a reflectively coated end face or specularly reflective end face of the beam splitter, is dependent only on the geometry of the beam splitter.

If the device comprises a plurality of coherent light sources, in particular two lasers, then the measurement results associated with the two lasers can be taken into account in the measurement. By way of example, one of the lasers may have an up-chirp, and the other of the lasers may have a down-chirp. A Doppler shift, that is to say a movement of the object, can advantageously be detected as a result.

A Doppler-free measurement of the object is made possible by means of a measurement of the object that is separated via the two partial measurement arms. In other words, the result of the measurement is independent of a relative movement or oscillations of the object. By means of the beam splitter, a Doppler-free measurement can be carried out with only one laser.

Furthermore, the two lasers can be unambiguously identified and thus separated by way of their chirp in the frequency domain.

In addition, the device can be centered on an identical measurement length within the two partial measurement arms. The centering mentioned is present if the beat frequencies of the lasers in the partial measurement arms differ by a defined constant value corresponding to an optical path length difference within the first retardation element for the two partial measurement arms. An approximately constant size of the measurement spot can advantageously be achieved as a result. If the object has approximately circular contour lines, then the measurement can be optimized by the centering since both partial measurement arms have their focus on the surface of the object.

In accordance with one advantageous configuration of the invention, a respective shutter is arranged within the first and second partial measurement arms.

The first and second partial measurement arms can advantageously be differentiated as a result. By way of example, firstly a measurement by means of the first partial measurement arm can be carried out by the associated shutter being opened and by the shutter associated with the second partial measurement arm being closed. In other words, the measurement is carried out only by means of the first partial measurement arm. Subsequently, a measurement can be carried out only by means of the second partial measurement arm in an analogous way. In other words, it is possible to switch between the two partial measurement arms by means of the shutters.

In accordance with a particularly preferred configuration of the invention, said device comprises an optical retardation section for increasing the optical path length of the first partial measurement arm relative to the optical path length of the second partial measurement arm.

The optical retardation section mentioned forms a further retardation section with respect to the retardation section associated with the first retardation element, and can thus be differentiated from the retardation section of the first retardation element, which is variable or adjustable by means of the displacement element.

An adjustment of the beam axes of the partial measurement arms can advantageously be carried out by means of the (further) retardation section. Furthermore, measurement deviations, for example as a result of a tilting of the device, can be reduced.

It is particularly preferred here to arrange a material, in particular glass, having a refractive index of greater than 1, in particular greater than 1.4, within the optical retardation section.

Furthermore, the material can preferably have a refractive index of greater than 1.5, in particular greater than 1.6, particularly preferably greater than 2.0.

Advantageously, an alternative or supplementary distinguishability between the partial measurement arms is made possible by the (further) retardation section and the material arranged within the retardation section. That is the case since the partial measurement arms can be differentiated by means of their associated beat frequency on account of their different optical path lengths. Advantageously, the partial measurement arms can be operated temporally in parallel, in particular without associated shutters, as a result.

In other words, the optical path and the geometric path become separable from one another by the material, i.e. it holds true that L_{optical}=L_{geometric}·(nₘₐₜₑᵣᵢₐₗ−n_{surroundings}), wherein L_{optical} denotes the optical path length, L_{geometric} denotes the geometric path length (spacing), nₘₐₜₑᵣᵢₐₗ denotes the refractive index of the material and n_{surroundings} denotes the refractive index of the ambient medium, in particular of air. The refractive indices typically have a frequency dependence. Moreover, they may be dependent on the temperature, the air pressure and/or further ambient parameters.

By means of the material, by way of example, the focus of the first partial measurement arm is displaced relative to the focus of the second partial measurement arm (without the material). Asymmetrical operation of the device is made possible as a result. In particular, the beat frequencies of the partial measurement arms can thereby be separated as widely as possible in the frequency domain. In other words, the difference between the beat frequencies in terms of absolute value is as great as possible. As a result, the measurement advantageously becomes more robust vis-à-vis disturbance influences. Since the light beam of the first partial measurement arm (with material) passes through the optical retardation section on its outgoing and return paths, it is typically sufficient to choose the separation of the beat frequencies in accordance with the outgoing path and return path with a sufficient magnitude. Furthermore, the retardation section can be formed by means of a mirror, which is tiltable, in particular. It is thereby possible to compensate for deviations in the beam path between the first and second partial measurement arms.

In accordance with one particularly preferred configuration of the invention, the beam splitter element is designed for splitting the measurement arm into the first and second partial measurement arms, and into a third and a fourth partial measurement arm.

It is particularly preferred here if the directions of the partial measurement arms in total form the shape of a cross, such that there is an angle of approximately 90° between respectively two partial measurement arms. In particular, in this case the partial measurement arms preferably extend in a plane. By way of example, internal diameters of the object can thereby be measured efficiently and as accurately as possible.

In one advantageous development of the invention, the device comprises a second retardation element and a beam splitter element for splitting the measurement arm into a first and a second partial measurement arm, wherein the beam splitter element is arranged upstream of the retardation elements, in particular directly upstream of the retardation elements, and the first retardation element is arranged within the first partial measurement arm and the second retardation element is arranged within the second partial measurement arm.

The device formed thereby can also be referred to as device of the third type. On account of the two retardation elements and the associated displacement elements, the device of the third type can be referred to symbolically as an optical double trombone.

Advantageously, by virtue of the two retardation elements, a device for measuring the object is provided which has at least two partial measurement arms whose optical path lengths are variable and/or adjustable independently of one another.

In other words, it is preferred for the optical path lengths of the retardation elements to be varied and/or adjusted together and/or separately from one another by means of the displacement elements. A common displacement element can be provided for joint adjustment of the optical path lengths of the retardation elements.

In accordance with one advantageous configuration of the invention, the device of the third type comprises an optical retardation section for increasing the optical path length of the first partial measurement arm relative to the optical path length of the second partial measurement arm.

In this case, the optical retardation section is preferably arranged upstream of the retardation elements. In other words, the optical path length of the first partial measurement arm is increased relative to the optical path length of the second partial measurement arm before the measurement arm is split into the partial measurement arms.

Furthermore, it is preferred in the case of the device of the third type, too, to arrange a material, in particular glass, having a refractive index of greater than 1, in particular greater than 1.4, in particular greater than 1.5, in particular greater than 1.6, preferably greater than 2.0, within the optical retardation section.

### BRIEF DESCRIPTION OF THE DRAWINGS

Further advantages, features and details of the invention are evident from the following exemplary embodiments described and also with reference to the drawing, in which, in a schematic fashion:

FIG. 1 shows a first configuration of a device according to the invention comprising a first retardation element;

FIG. 2 shows a configuration of the first retardation element;

FIG. 3 shows a second configuration of a device according to the invention comprising a first and a second partial measurement arm;

FIG. 4 shows a configuration of the device illustrated under FIG. 3;

FIG. 5 shows a further configuration of the device illustrated under FIG. 4;

FIG. 6 shows a third configuration of a device according to the invention comprising a first and a second retardation element;

FIG. 7 shows a configuration of the device illustrated under FIG. 6;

FIG. 8 shows a further configuration of the device illustrated under FIG. 6; and

FIG. 9 shows a further configuration of the device illustrated under FIG. 6.

### DETAILED DESCRIPTION

Elements that are of identical type, equivalent and/or act identically may be provided with the same reference signs in one figure and/or in the figures.

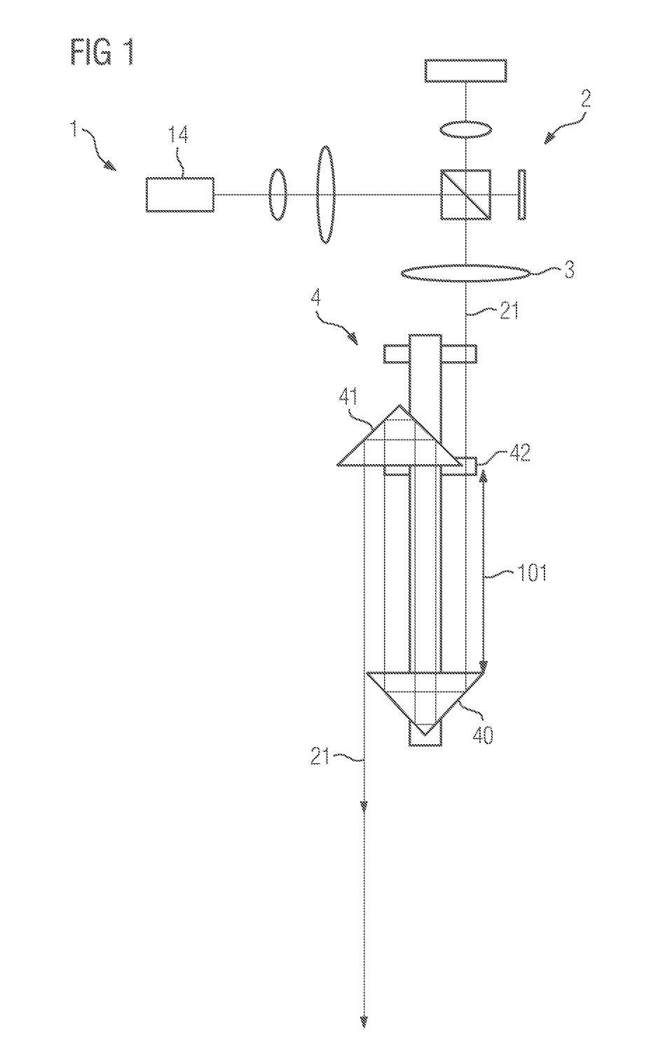

FIG. 1 shows a schematic first configuration of a device 1 according to the invention comprising a first retardation element 4. The device 1 constitutes a device of the first type within the meaning of the description.

The device 1 comprises an interferometer 2, which is embodied by way of example as a Michelson-Morley interferometer. The interferometer 2 has at least one coherent light source 14, in particular a laser. Furthermore, the interferometer 2 comprises a plurality of lens elements and mirrors and at least one beam splitter. The beam splitter of the interferometer 2 is provided for splitting the light beam or the light of the coherent light source 14 into a measurement beam and a reference beam. The measurement beam corresponds to at least one measurement arm 21 of the interferometer 2.

The device 1 furthermore comprises a focusing element 3, which is a focusing lens element, for example.

Furthermore, the device 1 has, according to the invention, the first retardation element 4. The first retardation element 4 is arranged downstream of the focusing element 3 within the measurement arm 21 and has at least one displaceable or movable displacement element 42. By means of the displacement element 42, the optical path length of the light beam (measurement beam) associated with the measurement arm 21 within the first retardation element 4 is variable, adjustable, controllable, regulatable and/or adaptable.

The first retardation element 4 has a first and a second deflection element 40, 41. In the first exemplary embodiment illustrated, the deflection elements 40, 41 are formed in each case by a prism. In this case, the prisms 40, 41 are spaced apart with respect to the direction of the measurement arm 21 and are arranged with an additional offset with respect to one another. As a result, the light beam associated with the measurement arm 21 is reflected back and forth multiply between the prisms 40, 41 before it leaves the device 1 and impinges on the object to be measured (not illustrated) or the surface thereof.

The measurement beam is reflected for example at least four times within the first and second deflection elements 40, 41 (prisms). In this case, two reflections within the first deflection element 40, which in total bring about a change in direction of the light beam by approximately 180°, are followed by respectively two comparable reflections within the second deflection element 41. In this case, the light beam associated with the measurement arm 21 extends approximately in a plane. In other words, the beam path associated with the measurement arm 21 is formed approximately in a plane.

By means of the displacement element 42 provided according to the invention, in the exemplary embodiment illustrated, the second deflection element 41 can be displaced in the direction of the measurement arm 21 or parallel to the direction of the beam path associated with the measurement arm 21. In the case of a displacement or movement of the displacement element 42, the spacing between the first deflection element 40 and the second deflection element 41 is increased or decreased, such that the optical path length of the light beam is varied within the first retardation element 4. As a result, the device 1 symbolically forms a type of optical trombone.

By virtue of the variable optical path length of the light beam within the first retardation element 4, the size of the measurement spot associated with the measurement beam can be adapted. In this case, the adaptation is carried out in such a way that the size of the measurement spot on the object remains approximately constant independently of the spacing between the device 1 and the object. In other words, the device 1 ensures a constant size of the measurement spot even upon a change in the spacing between the device 1 and the object to be measured.

In this case, the first retardation element 4 is preferably arranged downstream of the focusing element 3. In other words, the light beam generated by the coherent light source 14 is firstly split into a reference beam and a measurement beam by means of the interferometer 2. The interference between said reference beam and the measurement beam is used during the detection of a measurement signal which underlies the optical measurement of the object. The measurement beam corresponds to the measurement arm 21 of the device 1. A reference beam corresponds to the reference arm of the interferometer 2. The measurement beam is firstly guided through the focusing element 3, which brings about a focusing of the measurement beam. After said focusing, the measurement beam is guided to the first retardation element 4. Within the first retardation element 4, said measurement beam is multiply reflected back and forth, wherein at least one of the deflection elements 40, 41 is displaced by a displacement by means of the displacement element 42 and the optical path length of the measurement beam is thus varied within the first retardation element 4. After passing through the first retardation element 4, the measurement beam is projected onto the surface of the object to be measured. The change in the optical path length and thus the adaptation of the device 1 to a movement or a different spacing with respect to the object to be measured is represented by means of the dashed extension of the measurement arm 21. Furthermore, the movability of the displacement element 42 is identified by the arrow 101.

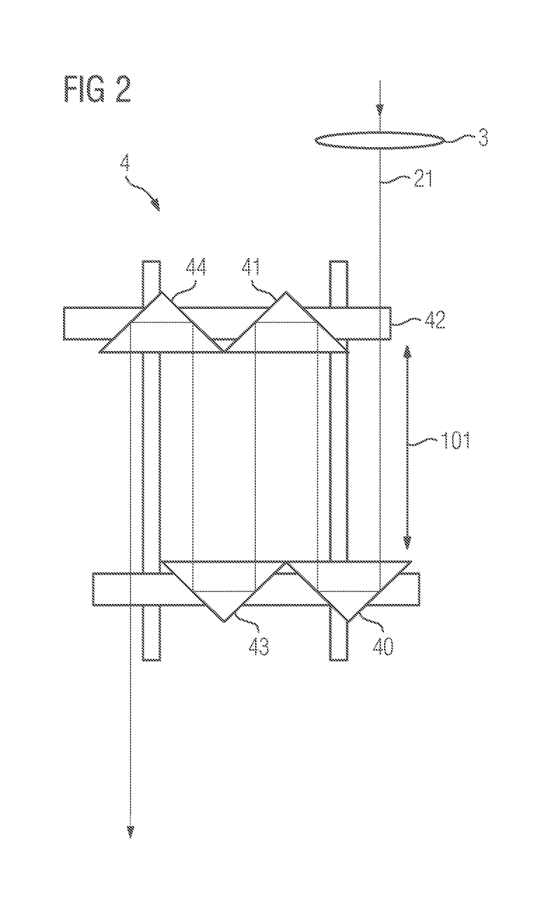

FIG. 2 illustrates a configuration of the first retardation element 4.

In the configuration illustrated, the first retardation element 4 comprises a first deflection element 40, a second deflection element 41, a third deflection element 43 and a fourth deflection element 44, which are embodied in particular in each case as a prism. The first and third deflection elements 40, 43 and the second and fourth deflection elements 41, 44 are respectively arranged alongside one another. Furthermore, the second deflection element 41 and the fourth deflection element 44 are coupled to the displacement element 42 in such a way that they are jointly movable.

A light beam that enters the first retardation element 4 is reflected twice here within each of the deflection elements 40, 41, 43, 44, such that the measurement beam experiences in total a change in direction by 180° in each deflection element 40, 41, 43, 44.

An arrow 101 once again indicates the movability of the displacement element 42.

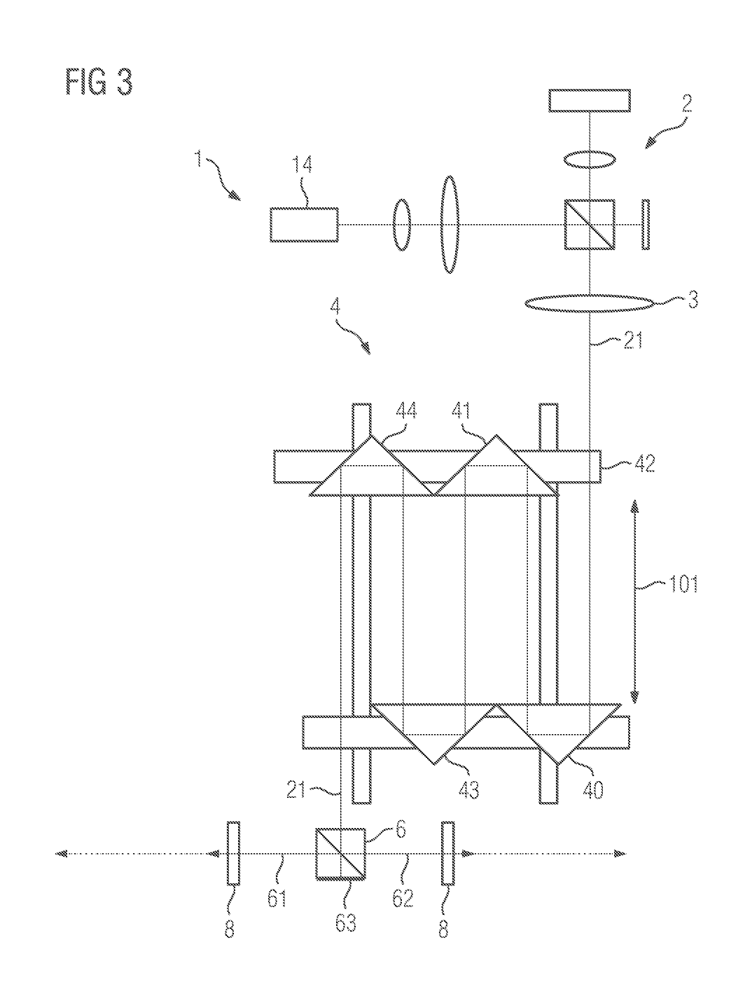

FIG. 3 illustrates a second configuration of a device according to the invention comprising a first and a second partial measurement arm 61, 62. FIG. 3 shows a configuration of the device illustrated under FIG. 1 inter alia with a first retardation element 4 in accordance with FIG. 2. In this case, the device 1 illustrated in FIG. 3 comprises the same elements as already in FIG. 1 and FIG. 2, respectively. Consequently, the statements made in respect of FIG. 1 and/or FIG. 2 can be applied directly to FIG. 3.

Supplementarily to FIG. 1 or FIG. 2, the device 1 illustrated in FIG. 3 has a beam splitter 6. The device 1 shown thus constitutes a device of the second type within the meaning of the description.

The beam splitter can be embodied as a polarization beam splitter and/or a mirror. By means of the beam splitter 6, the measurement arm 21 downstream of the first retardation element 4 is split into the first partial measurement arm 61 and a second partial measurement arm 62. In other words, the measurement beam downstream of the retardation element 4 is split into the first partial measurement beam 61 and the second partial measurement beam 62. The splitting can be on equal terms, that is to say that the beam splitter 6 is embodied in particular as a symmetrical 50/50 beam splitter. An asymmetrical splitting deviating therefrom can be provided.

The partial measurement arms 61, 62 extend in diametrical directions with respect to one another. An advantageous measurement of diameters or internal diameters of the object can be carried out as a result.

Shutters 8 are provided for differentiation of the partial measurement arms 61, 62 in an evaluation. Each of the partial measurement arms 61, 62 has one of the shutters 8. Switching between the partial measurements arms 61, 62 can advantageously be carried out as a result. A temporally separate or temporally spaced measurement of the object by means of the first partial measurement arm 61 or by means of the second partial measurement arm 62 is made possible as a result.

An end face 63 of the beam splitter 6 is reflectively coated in this case.

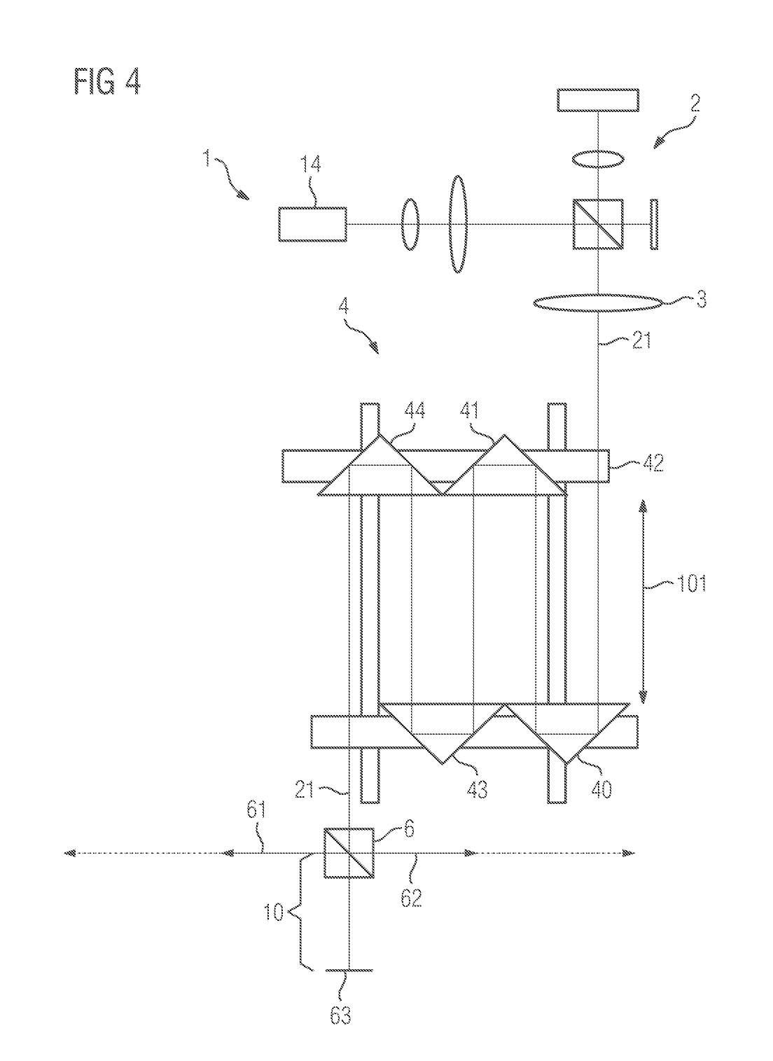

A retardation section 10 can be provided for improved separation or differentiation of the partial measurement arms 61, 62. A simultaneous measurement by means of the partial measurement arms 61, 62 is made possible as a result. A corresponding configuration of the device according to the invention which makes this possible is illustrated in FIG. 4.

FIG. 4 shows a configuration of the device illustrated under FIG. 3. Supplementarily to FIG. 3, the retardation section 10 is provided downstream of the beam splitter 6. In order to form the retardation section 10, the previously (see FIG. 3) reflectively coated end face 63 of the beam splitter 6 is arranged in a manner spaced apart therefrom. As a result, the first partial measurement beam 61 has an increased optical path length relative to the second partial measurement beam 62. In other words, the first partial measurement beam 61 is retarded relative to the second partial measurement beam 62. The beam axes of the partial measurement arms 61, 62 can advantageously be adjusted as a result. Furthermore, measurement deviations, for example as a result of a tilting of the device 1, can be reduced.

Furthermore, by means of a light reflected from the beam splitter 6 back into the retardation section 10, it is possible to determine the refractive index of the ambient medium of the device 1, as described above.

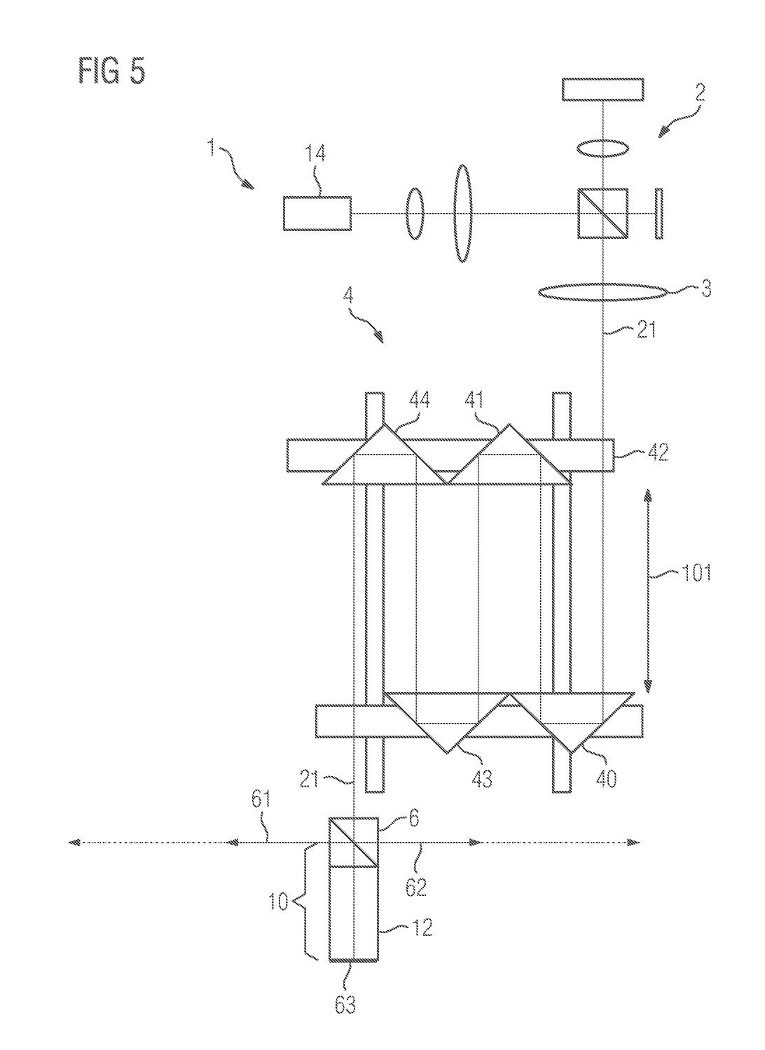

FIG. 5 illustrates a further configuration of the device illustrated under FIG. 4, which enables a distinguishability of the partial measurement arms 61, 62 by means of a material 10 arranged within the retardation section 10. In this case, the material 10 has a refractive index of greater than 1, in particular greater than 1.4, in particular greater than 1.5, in particular greater than 1.6, preferably greater than 2.0. The material 10 can preferably extend approximately over the entire retardation section 10. The material 10 can be embodied as a glass block.

Together with the material, the retardation section 10 leads to a frequency shift between the measurement signals associated with the partial measurement arms 61, 62. As a result, the partial measurement arms 61, 62 or their associated measurement signals can be separated in an improved manner in the frequency domain, that is to say with regard to their beat frequency, as a result of which a differentiation between the first and second partial measurement arms 61, 62, in particular in the case of simultaneous measurement, is made possible.

For the rest, FIG. 5 shows the same elements as already shown by FIG. 4. In particular, the refractive index of the ambient medium of the device 1 can be determined as already in FIG. 4.

The additional material 10 relative to FIG. 4 enables the separation of the partial measurement arms 61, 62 by way of their beat frequency. Furthermore, a tilting of the end mirror 63 provided at the end of the retardation section 10 makes it possible to reduce a tilting of the first and/or second partial measurement arm 61, 62 or of their associated beam axes or measurement axes.

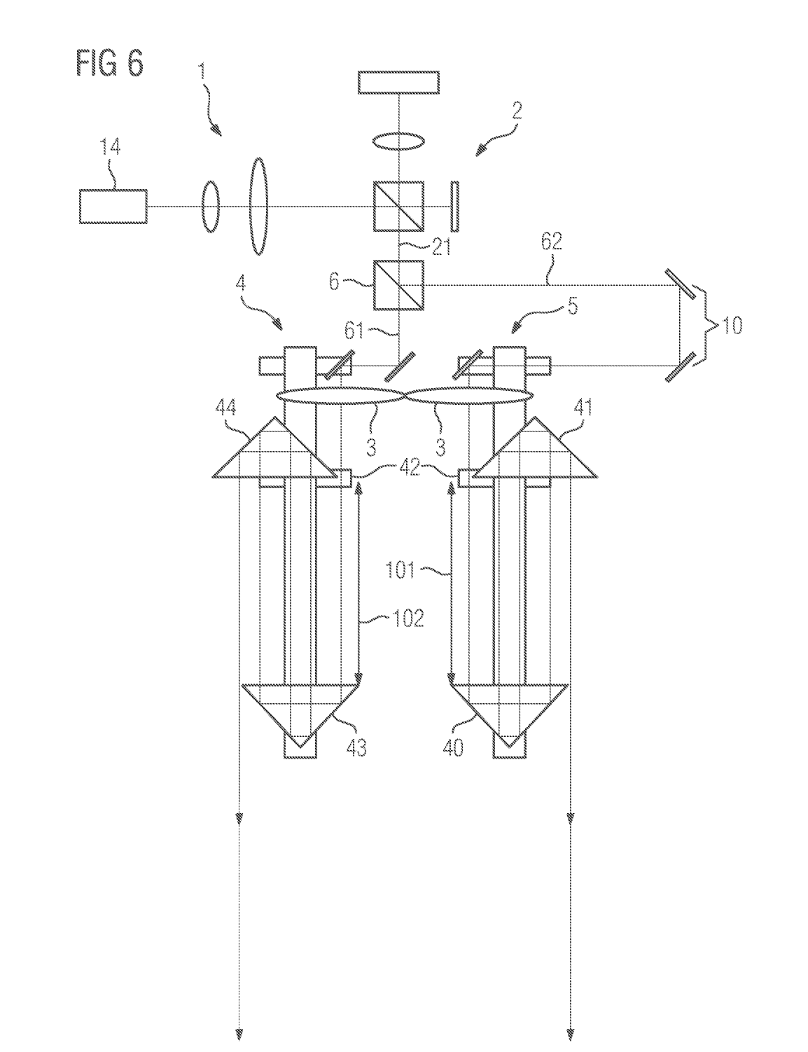

FIG. 6 illustrates a third configuration of a device according to the invention comprising a first and a second retardation element 4, 5. The device 1 as shown constitutes a device of the third type within the meaning of the description.

In comparison with the devices illustrated under FIGS. 1 to 5, the device 1 illustrated comprises a first and a second retardation element 4, 5. Furthermore, the device 1 comprises a beam splitter 6 arranged upstream of the retardation elements 4, 5. The beam splitter 6 splits the measurement arm 21 into a first and a second partial measurement arm 61, 62. In other words, the splitting of the measurement arm 21 into the first and second partial measurement arms 61, 62 takes place—in contrast to the device in FIGS. 3, 4 and 5—upstream of the retardation elements 4, 5. The first retardation element 4 is arranged within the first partial measurement arm 61 and the second retardation element 5 is arranged within the second measurement arm 62. As a result, the device 1 symbolically forms an optical double trombone.

The further elements of the device 1 illustrated in FIG. 6 correspond to the elements in FIGS. 1 to 5.

Further deflection elements, in particular mirrors, for example as illustrated, can be provided for further deflection or alignment of the beam paths of the partial measurement arms 61, 62.

The retardation elements 4, 5 respectively have a displacement element 42, which are not coupled to one another here, such that the retardation elements 4, 5 are movable and variable with regard to their optical path length differently than one another. This enables in each case an approximately constant size of the measurement spot in different directions.

The changes in the optical path lengths are indicated symbolically by the arrows 101, 102.

Furthermore, the optical path length of the second partial measurement arm 62 is increased relative to the optical path length of the first partial measurement arm 61 upstream of the retardation elements 4, 5 by means of a retardation section 10. The retardation section 10 can be formed by means of mirrors, for example as illustrated. A spectral separation of the first and second partial measurement arms 61, 62 or of their associated beat frequencies or measurement signals can be effected by the retardation section 10. That is the case since the frequency shift of the beat frequencies that are assigned to the partial measurement arms 61, 62 is proportional to the retardation. As a result, the first and second partial measurement arms 61, 62 can advantageously be operated temporally in parallel. Furthermore, with regard to the retardation section 10, reference should be made to the explanations in respect of FIG. 5.

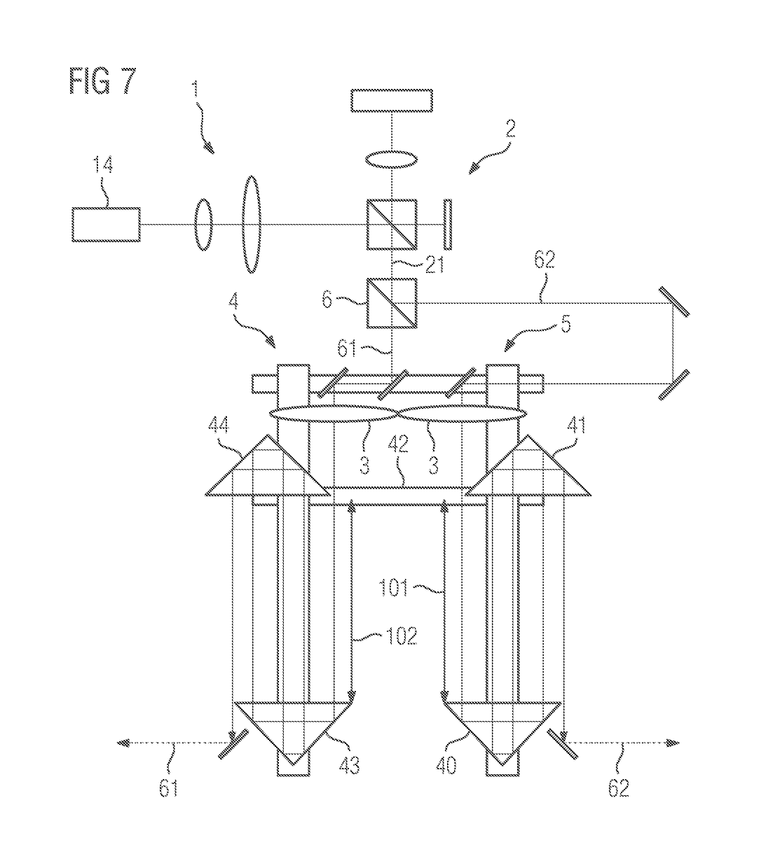

FIG. 7 shows a configuration of the device illustrated under FIG. 6.

The device illustrated in FIG. 7 shows substantially the same elements as the device under FIG. 6.

In comparison with FIG. 6, the retardation elements 4, 5 here have a common displacement element 42. As a result, the optical path lengths of the retardation elements 4, 5 can be jointly varied or adapted.

By means of the further deflection elements, for example mirrors, which are arranged downstream of the retardation elements 4, 5, a diametric measurement is made possible via the coupled partial measurement arms 61, 62.

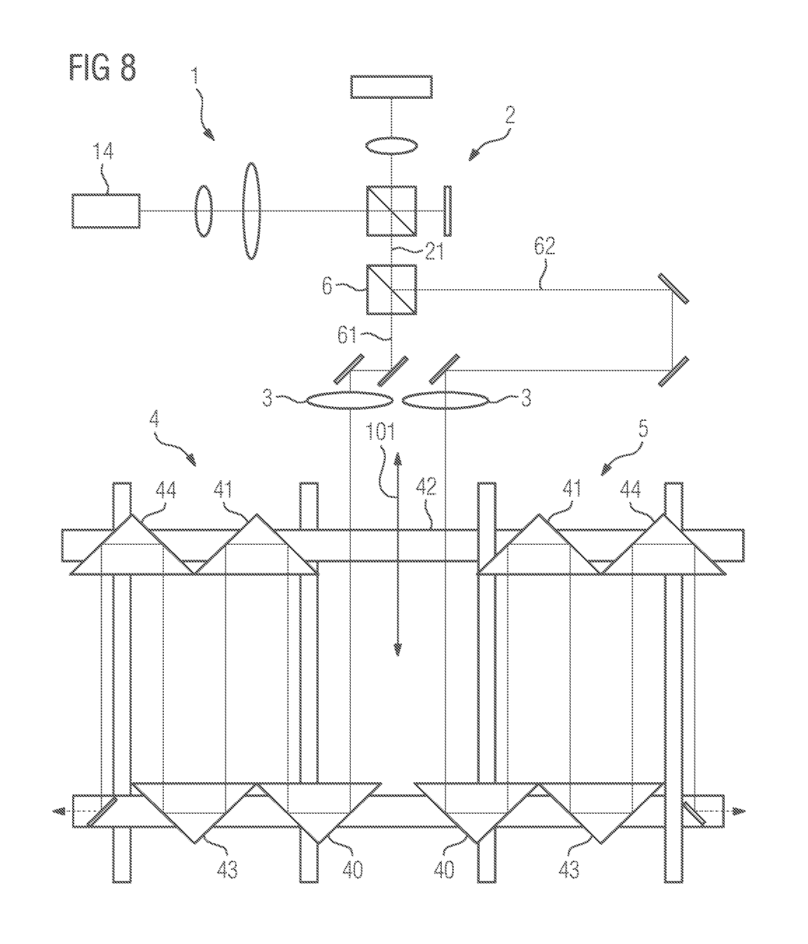

FIG. 8 shows a further configuration of the device illustrated under FIG. 6 or FIG. 7. Here the retardation elements 4, 5 from FIG. 7 are replaced in each case by a retardation element configured in accordance with FIG. 2. In other words, each of the retardation elements 4, 5 has at least four deflection elements 40, 41, 42, 43, which are embodied in particular in each case as a prism.

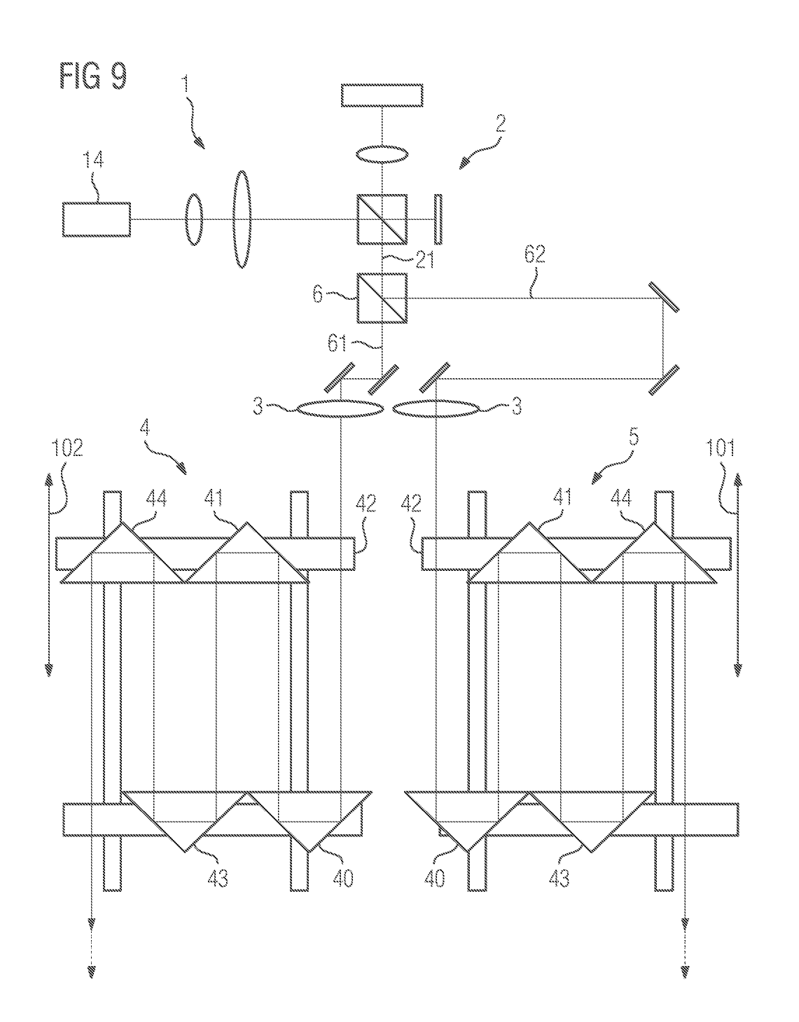

FIG. 9 shows a further configuration of the device illustrated under FIG. 6 or FIG. 8.

In contrast to FIG. 8, the retardation elements 4, 5 are movable separately from one another. In other words, each of the retardation elements 4, 5 has at least one displacement element 42, which can be operated and thus moved separately from one another. For the rest, FIG. 9 shows the same elements as already shown by FIG. 6 or FIG. 8.

If the devices in FIGS. 6 to 9 have an additional beam splitter having an end face comparable to the devices in FIGS. 4 and 5 within the partial measurement arms 61, 62, then in the partial measurement arms it is possible to determine the respective refractive index of the ambient medium in the partial measurement arms 61, 62. It is thereby possible to determine a difference in the refractive index of the ambient medium in the partial measurement arms 61, 62 such that said difference can be taken into account in the measurement.

The present invention provides a type of optical trombone or double trombone by means of which an object can be measured in accordance with the basic principle of a laser radar. A major advantage of the present invention is that by means of the displacement of the at least one displacement element, said displacement being comparable to a trombone or double trombone, a constant size of the measurement spot on the surface of the object is achievable independently of the spacing between the object and the device.

Although the invention has been more specifically illustrated and described in detail by means of the preferred exemplary embodiments, nevertheless the invention is not restricted by the examples disclosed and other variations can be derived therefrom by the person skilled in the art, without departing from the scope of protection of the invention.

What is claimed is:

1. A device (1) for optically measuring an object, comprising an interferometer (2) having a measurement arm (21), wherein the measurement arm (21) is provided for optically measuring the object, and a focusing element (3) arranged within the measurement arm (21), characterized in that the device (1) comprises a first retardation element (4) arranged within the measurement arm (21) and downstream of the focusing element (3), wherein the first retardation element (4) has a movable displacement element (42), by means of which the optical path length of the beam path of the measurement arm (21) is variable.

2. The device (1) as claimed in claim 1, characterized in that the interferometer (2) is embodied as a Michelson-Morley interferometer.

3. The device (1) as claimed in claim 1, characterized in that the first retardation element (4) comprises at least two deflection elements (40, 41), in particular prisms or mirrors, which are spaced apart from one another, wherein the deflection elements (40, 41), in addition to their being spaced apart, have an offset with respect to one another and the spacing of the deflection elements (40, 41) is variable by means of the movable displacement element (42).

4. The device (1) as claimed in claim 3, characterized in that the deflection elements (40, 41) are arranged in a manner rotated with respect to one another in such a way that the beam path of the first retardation element (4) extends outside a plane.

5. The device (1) as claimed in claim 1, characterized in that at least one area of the first retardation element (4) is at least partly reflectively coated in such a way that a light beam (400) passing through the first retardation element (4) is able to be returned at least partly to the interferometer (2).

6. The device (1) as claimed in claim 1, characterized in that said device comprises a sensor for detecting the movement of the movable displacement element (42).

7. The device (1) as claimed in claim 1 characterized in that said device comprises a beam splitter element (6) for splitting the measurement arm (21) into a first and second partial measurement arm (61, 62), wherein the beam splitter element (6) is arranged downstream of the first retardation element (4), and the partial measurement arms (61, 62) are provided for optically measuring the object.

8. The device (1) as claimed in claim 7, characterized in that a respective shutter (8) is arranged within the first and second partial measurement arms (61, 62).

9. The device (1) as claimed in claim 7, characterized in that said device comprises an optical retardation section (10) for increasing the optical path length of the first partial measurement arm (61) relative to the optical path length of the second partial measurement arm (62).

10. The device (1) as claimed in claim 9, characterized in that a material (12) having a refractive index of greater than 1, in particular greater than 1.4, is arranged within the optical retardation section (10).

11. The device (1) as claimed in claim 7, characterized in that the beam splitter element (6) is designed for splitting the measurement arm (21) into the first and second partial measurement arms (61, 62), and into a third and a fourth partial measurement arm.

12. The device (1) as claimed in claim 1, characterized in that said device comprises a second retardation element (5) and a beam splitter element (6) for splitting the measurement arm (21) into a first and a second partial measurement arm (61, 62), wherein the beam splitter element (6) is arranged upstream of the retardation elements (4, 5), and the first retardation element (4) is arranged within the first partial measurement arm (61) and the second retardation element (5) is arranged within the second partial measurement arm (62).

13. The device (1) as claimed in claim 12, characterized in that the optical path lengths of the retardation elements (4, 5) are variable together and/or separately from one another by means of the displacement element (42).

14. The device (1) as claimed in claim 12, characterized in that said device comprises an optical retardation section (10) for increasing the optical path length of the first partial measurement arm (61) relative to the optical path length of the second partial measurement arm (62).

15. The device (1) as claimed in claim 14, characterized in that a material (12) having a refractive index of greater than 1, in particular greater than 1.4, is arranged within the optical retardation section (10).
